(19) United States
(12) Patent Application Publication
(10) Pub. No.: US 2007/0271757 A1
(43) Pub. Date: Nov. 29, 2007

(54) COMBINED PROCESSING MACHINE AND PROCESSING METHOD USING THE SAME

(75) Inventors: Takaya NAGAHAMA, Kariya-shi (JP); Yoshio Wakazono, Nagoya-shi (JP); Koji Nishi, Anjo-shi (JP); Hiromichi Ota, Kariya-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: JTEKT Corporation, Osaka-shi (JP)

(21) Appl. No.: 11/751,819

(22) Filed: May 22, 2007

(30) Foreign Application Priority Data
May 23, 2006 (JP) 2006-142834

(51) Int. Cl. B23P 23/00

(52) U.S. Cl. 29/33 R

(57) ABSTRACT

A combined processing machine has a workpiece processing unit that is operable to move within a X-Z plane defined by an X-axis preset in a predetermined direction and a Z-axis perpendicular to the X-axis, a heat treatment tool to apply a heat treatment to a workpiece, and a tool mounting unit that is adapted to attach at least one of a shaping tool to shape the workpiece and a finishing tool to finish the workpiece to the workpiece processing unit. The heat treatment tool has a light focusing head to focus a light supplied through a light guiding portion from a laser oscillator on the workpiece.

The present application is based on Japanese patent application No. 2006-142834, the entire contents of which are incorporated herein by reference.

### BACKGROUND OF THE INVENTION

1. Field of the Invention

This invention relates to a combined processing machine that processes a workpiece by using various processing tools and multiple processing methods and, in particular, to a combined processing machine that uses a heat treatment tool such as a quenching tool. Also, this invention relates to a processing method using the combined processing machine.

2. Description of the Related Art

Conventionally, various machine tools such as a lathe turning machine, a drilling machine, a boring machine, a milling machine, a planing machine, a broaching machine and a grinding machine are used according to kind of processing. A machine is also known which can be adapted to not only single process but also various combined processes by means of NC control. Further, so-called combined processing machines are proposed which can perform collectively multiple processes, e.g., a lathe turning process and a grinding process. Furthermore, a combined processing machine with a heat treatment device is proposed (See, e.g., JP-A-S59-50983).

Although heat treatment devices such as a high-frequency heat treatment device and a carburizing heat treatment device are conventionally used, they are so large that they must cause an increase in initial cost and running cost. In addition, they are not adapted to a collective processing to be conducted without detaching a workpiece during a process from a crude processing through a heat treatment to a finishing.

In contrast, the combined processing machine of JP-A-S59-50983 uses, as the heat treatment device, a laser oscillator equipped nearby, where a laser processing is conducted by irradiating a part of a processed material with a light supplied from the laser oscillator through a mirror mounted on a machine tool and concentrated by a condensing lens. Therefore, the processing operations of the machine tool and the laser oscillator can be simultaneously performed on the one machine tool. Thus, since the multiple processing works can be performed collectively, the number of workers decreases and the working efficiency increases.

However, the combined processing machine of JP-A-S59-50983 fails to disclose a suitable combination of the laser oscillator to the combined processing machine. Therefore, it is problematic in terms of laser efficiency and space-saving performance.

### SUMMARY OF THE INVENTION

It is an object of the invention to provide a combined processing machine that can be enhanced in laser efficiency and space-saving performance and adapted to a collective processing to be conducted without detaching a workpiece from a main spindle thereof during a process from a crude processing through a heat treatment to a finishing, as well as a processing method using the combined processing machine.

(1) According to one embodiment of the invention, a combined processing machine comprises:

a workpiece processing unit that is operable to move within a X-Z plane defined by an X-axis preset in a predetermined direction and a Z-axis perpendicular to the X-axis;

a heat treatment tool to apply a heat treatment to a workpiece; and

a tool mounting unit that is adapted to attach at least one of a shaping tool to shape the workpiece and a finishing tool to finish the workpiece to the workpiece processing unit,

wherein the heat treatment tool comprises a light focusing head to focus a light supplied through a light guiding portion from a laser oscillator on the workpiece.

In the above embodiment (1), the following modifications and changes can be made.

(i) The heat treatment tool is previously attached to the workpiece processing unit.

(ii) The heat treatment tool is attached to the workpiece processing unit selectively in combination with at least one of the shaping tool and the finishing tool.

(iii) The laser oscillator comprises a semiconductor laser to oscillate a near-infrared laser light at a wavelength of 800 nm to 1000 nm, and the light guiding portion comprises an optical fiber.

(iv) The light focusing head is fixed to the workpiece processing unit through a clamping portion.

(v) The combined processing machine further comprising a cooling device that is operable to immediately cool the workpiece heated by the near-infrared laser light emitted from the heat treatment tool to quench the workpiece.

(vi) The cooling device comprises a coolant supplying nozzle to supply a coolant to the workpiece during the shaping or the finishing.

(2) According to another embodiment of the invention, a processing method by using the combined processing machine according to the embodiment comprises the steps of:

normalizing the workpiece by irradiating the workpiece with the near-infrared laser light by the heat treatment tool and then cooling the workpiece in the air to increase a workability of the workpiece; and

subsequently shaping the workpiece by the shaping tool and/or finishing the workpiece by the finishing tool.

### BRIEF DESCRIPTION OF THE DRAWINGS

The preferred embodiments according to the invention will be explained below referring to the drawings, wherein:

FIG. 1 is a plain view showing a combined processing machine in a preferred embodiment according to the invention, where a light focusing head 600 as a heat treatment tool is mounted on a workpiece processing unit 200;

FIG. 2 is a plain view showing the combined processing machine in the preferred embodiment according to the invention, where the light focusing head 600 is housed in a tool pod 402 of a tool mounting unit 400 by being tool-exchanged after the light focusing head 600 shown in FIG. 1 is mounted on the workpiece processing unit 200;

FIG. 3 is a perspective view showing a heat treatment tool 504 comprising a laser oscillator, a light focusing head and an optical fiber to provide optical connection between the both of them;

FIG. 4 is a flowchart showing an example of a processing operation by the combined processing machine in the preferred embodiment; and

FIG. 5 is a graph showing a relationship between an oscillation wavelength and an absorptance of workpiece W.

### DETAILED DESCRIPTION OF THE PREFERRED EMBODIMENTS

### Composition of Combined Processing Machine

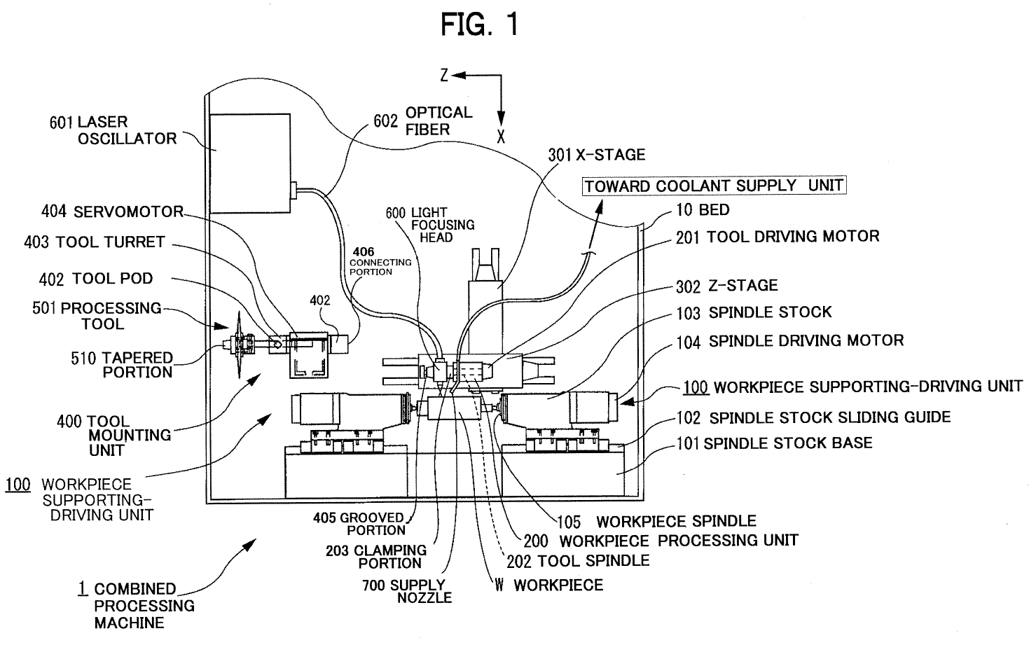

FIG. 1 is a plain view showing a combined processing machine in a preferred embodiment according to the invention, where a light focusing head 600 as a heat treatment tool is mounted on a workpiece processing unit 200. Meanwhile, in FIG. 1, its vertical direction is defined as X-direction, and its horizontal direction is defined as Z-direction.

The combined processing machine 1 is controlled in its whole drive by a computer numerical control (CNC) device (not shown), and comprises a combined processing machine body and attachment devices (not shown). The attachment devices include a laser oscillator, an oil supply unit, a cooling device, an air supply unit, a coolant supply unit, a chip collecting device, and a duct system for connecting these devices to the combined processing machine body.

The combined processing machine 1 is mounted on a bed 10, and the machine 1 comprises a workpiece supporting-driving unit 100 to support a workpiece W such as a shaft to be rotatably drivable, a X-stage 301 and a Z-stage 302 guided on the bed 10, to determine a movement and a positioning in X-direction and Z-direction, a workpiece processing unit 200 mounted on the Z-stage 302, to mount various processing tools as freely attached and removed, and a tool mounting unit 400 to attach or remove the processing tools to or from a certain position of the workpiece processing unit 200. Further, the workpiece processing unit 200 can be a unit that moves not only in the X-direction and Z-direction by the X-stage 301 and Z-stage 302, but also within an X-Z plane, for example, by so-called parallel mechanism where closed link mechanisms are disposed in parallel with each other.

The workpiece supporting-driving unit 100 comprises left and right spindle stocks 103 installed in a spindle stock base 101 mounted on the bad 10, and the spindle stocks 103 being slidably movable through left and right spindle stock sliding guides 102, and spindle driving motors 104 to rotatably drive a workpiece spindle 105 at a certain rotation speed are installed in the spindle stocks 103. Each of the left and right spindle stocks 103 can slide in the Z-direction independently, can sandwich the workpiece W between certain cores, and can fix the position of workpiece W.

The workpiece processing unit 200 rotatably drives a tool spindle 202 on which a processing tool 501 is mounted, at a certain rotation speed by a tool driving motor 201, if the process is conducted by rotations of the processing tool such as a grinding process tool and the workpiece W. Further, the workpiece processing unit 200 is fixed at a certain rotating position, with a certain static stiffness, without the rotation of the tool spindle 202 on which the processing tool 501 is mounted, if the process is conducted by only the rotation of workpiece W without the rotation of the processing tool such as a turning process tool, a heat treatment process tool.

Further, in a case of rotating a process tool such as a grinding process tool, a rotation drive system using gears or belts or a traction drive system utilizing a friction conduction can be also used, other than the rotation drive system using a tool driving motor 201 connected directly to the tool.

The tool spindle 202 comprises a clamping portion 203 to cramp a tapered portion 510 of the processing tool 501, so that the processing tool 501 and the tool spindle 202 are solidly connected. In particular, the clamping portion 203 is formed based on standards comprising compatibility such as HSK interface standard for the combined processing machine. In the case that the clamping portion 203 is formed based on the HSK interface standard, the tapered portion 510 of the processing tool 501 and the end surface can be solidly connected to the tool spindle 202 by the two-surface contact.

A tool mounting unit 400 is mounted on a certain position of the bed 10, and has a tool turret 403 with multiple tool pods 402 capable of holding various processing tool 501 and a servomotor 404 to index the tool turret 403 around the X-axis. Inside of the tool pods 402, a connecting portion 406 is formed with a ball bush such that a grooved portion 405 formed at the end of the processing tools 501 can be detached from the connecting portion 406 when applying a predetermined force or greater thereto.

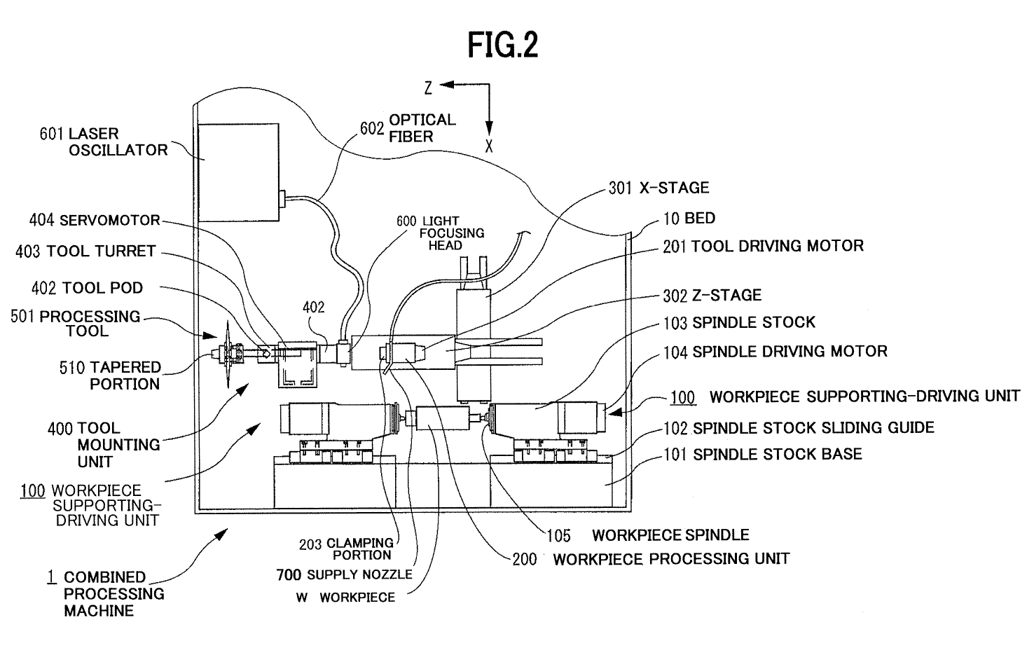

FIG. 2 is a plain view showing the combined processing machine in the preferred embodiment according to the invention, where a light focusing head 600 is housed in the tool pod 402 of the tool mounting unit 400 by being tool-exchanged after the light focusing head 600 shown in FIG. 1 is mounted on the workpiece processing unit 200. After this, in case of attaching the other processing tool 501 to the workpiece processing unit 200, the tool turret 403 is rotated by 180 degrees around the X-axis by the servomotor 404, so as to move the other processing tool 501 to an installable position on the workpiece processing unit 200. Then, the Z-stage 302 is driven to move the workpiece processing unit 200 to the other processing tool 501 and the other processing tool 501 is fixed to the workpiece processing unit 200 through the clamping portion 203.

The processing tool 501 includes a turning tool 502 such as a lathe turning electrodeposition wheel used for a turning process, a cutting tool 503 such as a drill and an end mill used for a boring or grooving process, a heat treatment tool 504 such as a laser quenching head, a grinding tool 505 such as a grinding wheel (e.g., a CBN wheel) used for a grinding process, and a surface finishing tool 506 used for a superfinishing, an ELID grinding etc. Herein, the turning tool 502 such as the lathe turning electrodeposition wheel and the cutting tool 503 such as the drill and the end mill used for the boring or grooving process can be collectively called as a shaping tool since they are mainly used to form a shape of the workpiece W. Also, the grinding tool 505 such as the grinding wheel and the surface finishing tool 506 used for the superfinishing or ELID grinding etc. can be collectively called a finishing tool since they are mainly used to render a desired accuracy and surface roughness of the workpiece W. Thus, by using the workpiece processing unit 200 and the tool mounting unit 400, one processing tool can be selected from the shaping tool, the heat treatment tool and the finishing tool in a predetermined sequence. Meanwhile, the heat treatment tool may be disposed at a preset position instead of being exchanged by the tool mounting unit 400.

The turning tool 502 includes a fixed turning tool to be used without being rotated, and a rotary tool to be used being rotated such as a lathe turning electrodeposition wheel. Further, the electrodeposition wheel means a wheel embedded bit chips or superabrasives such as diamond, CBN on the periphery of a wheel base material by nickel plating etc., and it is advantageous in tool cost.

The cutting tool 503 used for the boring, the grooving process includes a drill, a tap, an end mill, and a milling tool, and in this case, a direction of rotating power of the tool spindle 202 has to be converted, since the tools described above need a rotating drive around the axis thereof, that is, around the X-axis, but the rotation of the tool spindle 202 is a rotation around the Z-axis. The converting mechanism of the rotating direction can be constituted by, for example, bevel gears, and the bevel gears can be built in the tool. Further, a rotation driving means installed in the tool such as motor can be used, instead of using the rotating power of the tool spindle 202.

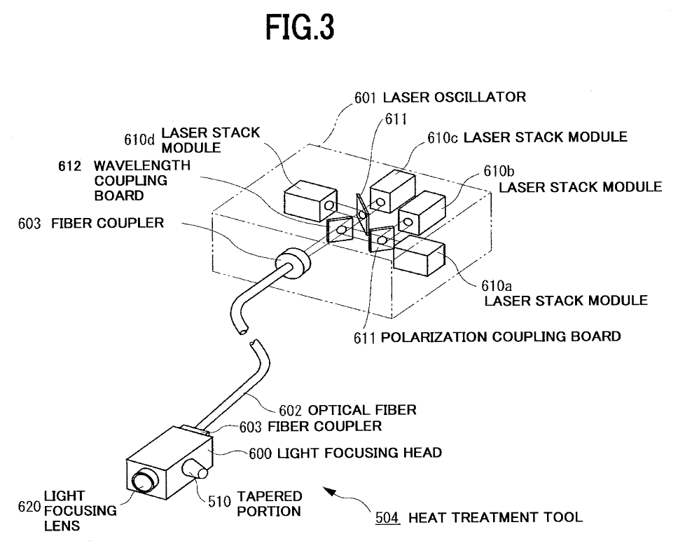

FIG. 3 shows a particular structure of the heat treatment tool 504 comprising the light focusing head 600, a laser oscillator 601, and an optical fiber 602.

The heat treatment tool 504 comprises the light focusing head 600, the laser oscillator 601, and the optical fiber 602. The laser oscillator 601 having a high-power is mounted on, for example, the bed 10, and the oscillator 601 is optically connected to one end of the optical fiber 602 through an optical fiber coupler 603, and further the other end of the optical fiber 602 is optically connected to the light focusing head 600 through an optical fiber coupler 603. The light focusing head 600 comprises a light focusing lens 620 to control a position in the X-direction to the workpiece W, so as to irradiate a laser beam light-guided from the laser oscillator 601 to the workpiece W at a certain beam size. Further, the heat treatment tool 504 is used for a heat treatment such as a quenching, a normalizing, an annealing and a tempering.

Furthermore, when the heat treatment tool 504 is used, it is necessary that heat treatment is performed under the condition that the rotating power of the tool spindle 202 is not used, the tool spindle 202 is fixed with a certain static stiffness, and the light focusing head 600 is fixed to the workpiece processing unit 200. In this case, the light focusing head 600 can be mounted on a place other than the workpiece processing unit 200, for example, the bed 10, instead of being mounted on the workpiece processing unit 200, and can be also mounted on a certain place, instead of being exchanged by the tool mounting unit 400.

The laser oscillator 601 comprises laser stack modules 610a, 610b, 610c, and 610d, polarization coupling boards 611, and a wavelength coupling board 612. The laser stack modules 610 are constituted by stacking plural laser light emitting elements so as to have a high output. Each of the laser stack modules 610 performs a beam shaping to have a collimated light with predetermined linear polarization, and then a beam synthesis by the polarization coupling boards 611.

Directions of polarization of the laser stack modules 610a, 610b to be synthesized are perpendicular to each other, for example, in case of the polarization coupling board 611 made of a Polaroid film, laser beam emitted from the laser stack module 610a is transmitted and laser beam emitted from the laser stack module 610b is reflected, so that one laser beam is synthesized from the two laser beams. The laser beams 610c, and 610d are also synthesized similarly.

The oscillation wavelengths of laser stack modules 610a, 610b are set to be different from those of laser stack modules 610c, 610d, and a wavelength coupling board 612 has a wavelength filter that transmits one of the different oscillation wavelengths and reflects another of those, so that one laser beam is synthesized on the emission side of wavelength coupling board 612.

The laser oscillators 601 constituted like this, for example, are stacked with 25 tiers at a distance of 2 mm between emission points, so that the optical output of synthesized laser beam comes to 1 kW. Further, the oscillation wavelength is near-infrared lights of 800 nm to 1000 nm, and in the embodiment, two wavelengths of 800 nm and 830 nm are adopted.

The optical fiber 602 is, for example, a silica optical fiber cable of 600 μm in diameter. The fiber cable length of the optical fiber 602 is set to be long enough for the light focusing head 600, as shown in FIG. 1, to move within a certain processing area while being mounted on the workpiece processing unit 200, and, as shown in FIG. 2, to move without causing a breaking of the optical fiber 602 and inhibiting free movement of other movable members even when being housed in the tool pod 402.

The light focusing head 600 has the light focusing lens 620 to focus the laser beam light-guided from the optical fiber 602 through the fiber coupler 603 on a processed surface of the workpiece W at a predetermined beam diameter.

The light focusing lens 620 has one lens or a combination of two lenses or more and, for example, has NA of 0.2 to focus the laser beam on the processed surface of the workpiece W at a predetermined laser beam diameter.

The laser beam diameter to be focused can be controlled according to the position of light focusing head 600 to the processed surface of workpiece W, for example, so that it can be set to vary within the range of 1 mm to 10 mm. Otherwise, a mechanism to move the light focusing lens 620 mounted on the light focusing head 600 in the light axis direction can be installed, so that the distance to the processed surface of the workpiece W can be varied, and the laser beam diameter to be focused can be also varied.

Further, the laser beam to be focused on the processed surface of the workpiece W can have a beam profile of almost rectangular shape. In the beam shaping in each of the laser stack modules 610, a far-field pattern is formed to an almost rectangular shape, so that the laser beam to be focused on the processed surface of the workpiece W can be also formed, for example, to an almost rectangular shape of 1 mm×1 mm to 10 mm×10 mm.

In the light focusing head 600, a tapered portion 510 to be cramped by a clamping portion 203 of the tool spindle 202 is formed. In particular, the tapered portion 510 is formed based on standards comprising compatibility such as HSK interface standard for the combined processing machine.

Further, a supply nozzle 700 as a cooling device to supply a forced cooling fluid such as a coolant to the processed surface of the workpiece W is mounted on the light focusing head 600. Even when the supply nozzle 700 is not mounted on the light focusing head 600, the supply nozzle 700 only has to supply the coolant to the processed surface of the workpiece W corresponding to the movement of light focusing head 600. The coolant supplied may be used commonly with a coolant for the shaping or finishing. The forced cooling means for the processed surface of the workpiece W may include water, air, liquid nitrogen etc. other the coolant.

Alternatively, the heat treatment may be conducted by a self-cooling method where the processed surface of the workpiece W after the heating is naturally cooled instead of using the forced cooling method.

It is preferable that the workpiece processing unit 200 comprises a restraint means such as a brake to keep the tool spindle 202 in a stopped state, a tool driving motor 201 by which the static torque of the tool spindle 202 can be set larger, or a control means comprising a large servo stiffness for stopping rotation to keep the tool spindle 202 in a stopped state. Further, when using tools such as a heat treatment tool 504 which are not used in a rotating state at the processing, the other fixing methods different from the connection of tapered portion 510 and clamping portion 203 can be also used.

A grinding tool 505 includes a CBN wheel comprising CBN (Cubic Boron Nitride) grinding stone, so as to achieve the grinding process with high accuracy.

A surface finishing tool 506 has a built-in vibration means such as an ultrasonic generator to provide vibration for the grinding stone so as to obtain a smooth surface by a superfinishing processing. Further, the surface finishing tool 506 has a grinding stone wheel for ELID grinding process formed by adhering diamond abrasive grains thereto with a cast iron bonding agent, and further has an electrolyte supply means and an electrolysis power source.

### EXAMPLE 1

### Of Processing Operation by Combined Processing Machine

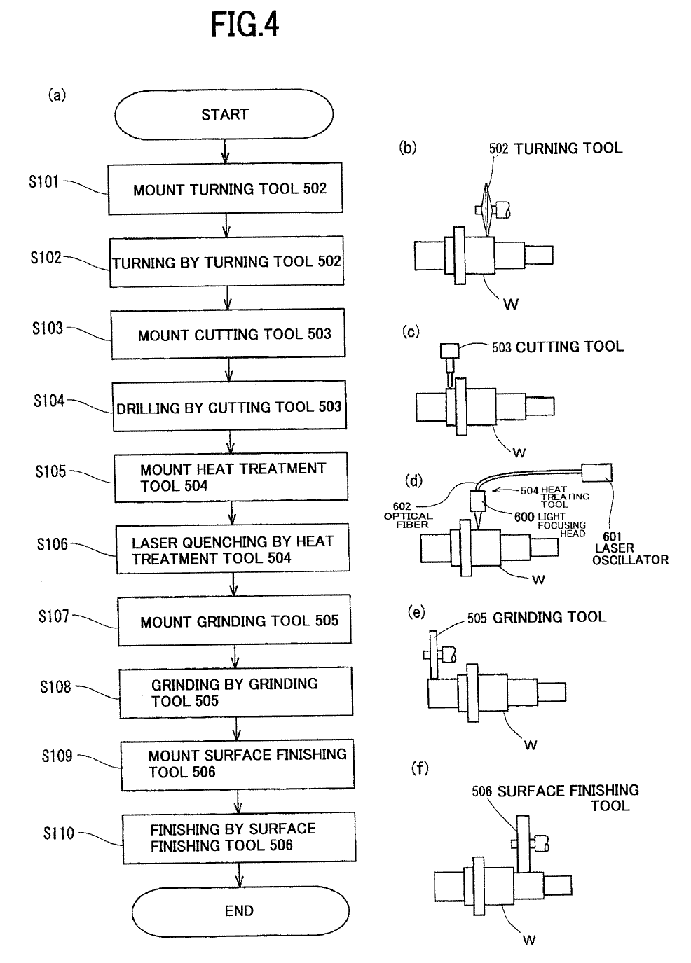

FIG. 4 is a flowchart (FIG. 4(a)) showing an example of a processing operation by the combined processing machine in the preferred embodiment. Example 1 of the processing operation comprises a turning process (as illustrated by FIG. 4(b)), a boring process (as illustrated by FIG. 4(c)), a laser quenching treatment (as illustrated by FIG. 4(d)), a grinding process (as illustrated by FIG. 4(e)), and a surface finishing process (as illustrated by FIG. 4(f)), where the processes are performed by the combined processing machine in the preferred embodiment while exchanging the processing tools in a given sequence.

When the workpiece W of a long size is set between the workpiece spindles 105 so as to support the workpiece W, and the process is started, the turning tool 502 is mounted on the workpiece processing unit 200 by the mounting process of turning tool 502 for turning process (S101). Then, the turning tool 502 is rotated at a rotating speed adapted to the material of the workpiece W, so as to perform the turning process (S102). By this process, the processing of the outer diameter of the workpiece W is completed.

Then, the boring process is conducted. After the turning tool 502 is housed into the tool turret 403, the cutting tool 503, that is, a drill is mounted on the workpiece processing unit 200 (S103). The rotations of the workpiece spindles 105 are stopped, and the drill is rotated in a stopped state of the workpiece W so as to cut it up to a certain depth, and the boring process is completed (S104).

Then, an on-the-machine quenching is conducted. After the cutting tool 503 is housed into the tool turret 403, the light focusing head 600 is mounted on the workpiece processing unit 200 (S105). The light focusing head 600 is moved at a quenching start position by the X-stage 301 and the Z-stage 302. The diameter of laser beam to be irradiated from the light focusing lens 620 to the processed surface of the workpiece W is determined by the a position of the light focusing head 600 in the X-direction. The light focusing head 600 is operated to be advanced at a certain speed by the Z-stage 302, while the workpiece spindles 105 are rotated so as to rotate the workpiece W at a certain rotating speed. Example 1 of the processing operation is performed at a quenching temperature of 1000° C., where an optical output of laser beam is 1 kW, a size of laser beam on the processed surface is 2 mm×2 mm, and a quenching speed is 5 mm/s.

The laser beam is irradiated from the light focusing lens 620 to the processed surface of the workpiece W so as to heat it at a temperature of 1000° C., and the coolant is supplied from the supply nozzle 700 to the processed surface so as to immediate cool it up to almost 200° C. The quenching process as described above is continuously performed within a certain heat treatment region, so as to provide the workpiece W with the quenching treatment from the surface to the depth of 3 mm (S106).

Then, a grinding process is conducted. After the light focusing head 600 is housed into the tool turret 403, the grinding tool 505 is mounted on the workpiece processing unit 200 (S107). The workpiece W is rotated at a rotating speed adapted to the materials of the grinding tool 505 and the workpiece W, so as to perform the grinding process (S108).

Finally, a surface finishing process of the workpiece W is conducted. After the grinding tool 505 is housed into the tool turret 403, the surface finishing tool 506 is mounted on the workpiece processing unit 200 (S109). By the surface finishing tool 506 mounted, the surface finishing process such as a superfinishing process, an ELID process, a lapping process, a polishing process, a buff finishing process is conducted (S110). According to the successive processes described above, almost all the processes from the shaping process to the finishing process can be achieved by only one combined processing machine. Further, in the Example 1 of processing operation described above, a processing operation that the shaping process, the heat treatment and the finishing process are combined together is shown, but a processing operation that the shaping process and the heat treatment are combined together, or a processing operation that the heat treatment and the finishing process are combined together can be easily applied.

In the above embodiment of the invention, the heat treatment tool can be detached from the workpiece processing unit and tool-exchanged by the tool mounting unit. However, another preferred embodiment of the invention may be also made in which the heat treatment tool is previously (always) attached to a different site than the mounting site of the shaping tool and the finishing tool on the workpiece processing unit.

### EXAMPLE 2

### Of Processing Operation by Combined Processing Machine

Normalizing is conducted up to a depth corresponding to a portion to be eliminated by the grinding or finishing process prior to the grinding process (S108) or the finishing process (S109) in Example 1 as described earlier. After the light focusing head 600 is mounted on the workpiece processing unit 200, the light focusing head 600 is moved to a normalizing start position by the X-stage 301 and the Z-stage 302. The diameter of laser beam irradiated from the light focusing lens 620 to the processed surface of the workpiece W is determined by a position of the light focusing head 600 in the X-direction. The light focusing head 600 is operated to be advanced at a certain speed by the Z-stage 302, while the workpiece spindles 105 are rotated so as to rotate the workpiece W at a certain rotating speed. In the Example 2 of processing operation, the normalizing is performed by heating the processed surface of the workpiece W at a temperature of 900° C. being not less than A3 transformation point, and cooling (standing to cool) it in the air. The other processes are conducted similarly to Example 1.

According to the preferred embodiment in the invention, the following advantages can be achieved.

(1) The heat treatment process such as the on-the-machine quenching which is difficult to perform by conventional machine tools can be conducted between a crude processing and a finishing without removing the workpiece W from the spindle, so that a processing method comprising a collective, consistent, and efficient process can be realized.

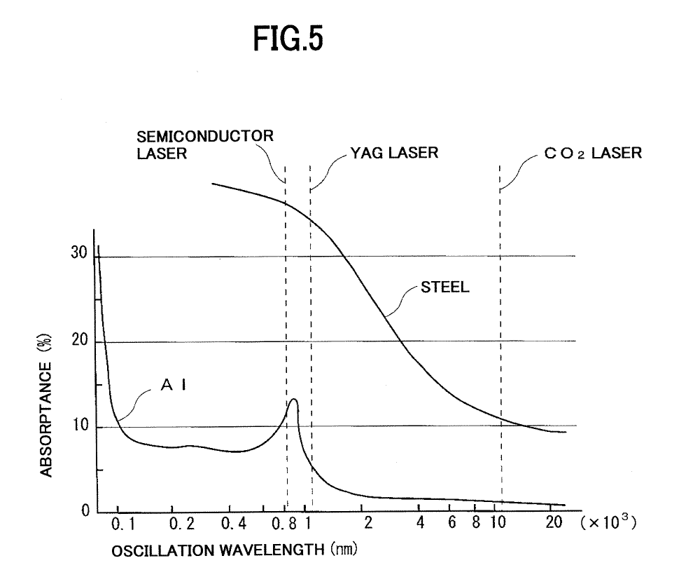

(2) Since the near-infrared semiconductor laser with an oscillation wavelength of 800 nm to 1000 nm is used as a laser oscillator, the absorptance of workpiece W is higher than that of the other lasers. FIG. 5 is a graph showing the relationship between an oscillation wavelength and an absorptance of workpiece W. The near-infrared semiconductor laser provides an absorptance for workpiece W much higher than a CO₂ laser with a wavelength of 10.6 μm (=10.6×10³ nm) and higher than even an Nb-YAG laser with a wavelength of 1.06 μm (=1.06×10³ nm). Thus, when the near-infrared semiconductor laser is used as a laser oscillator for steels where a heat treatment process such as a quenching process is frequently conducted, the processing efficiency can be enhanced. Further, the workpiece W made of aluminum (Al) material has an absorptance peak near 800 nm. Therefore, a shortening of lead time and a decrease in process cost can be drastically enhanced, and the laser oscillator can be constituted by a compact size, so that the installation area of the processing machine can be decreased.

(3) Various heat treatments can be performed to the workpiece W as the heat treatment process by changing the heat treatment condition. The normalizing process as shown in Example 2 of processing operation can be performed during the successive processing operation, on-the-machine, and by one chucking, other than the quenching process shown in Example 1 of processing operation. Metal structure can be refined by the normalizing process, so that strength and toughness thereof can be enhanced. By this, the workability in the shaping process and the finishing process of the workpiece W is also enhanced.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A combined processing machine, comprising:
a workpiece processing unit that is operable to move within a X-Z plane defined by an X-axis preset in a predetermined direction and a Z-axis perpendicular to the X-axis;
a heat treatment tool to apply a heat treatment to a workpiece; and
a tool mounting unit that is adapted to attach at least one of a shaping tool to shape the workpiece and a finishing tool to finish the workpiece to the workpiece processing unit,
wherein the heat treatment tool comprises a light focusing head to focus a light supplied through a light guiding portion from a laser oscillator on the workpiece.

2. The combined processing machine according to claim 1, wherein:
the heat treatment tool is previously attached to the workpiece processing unit.

3. The combined processing machine according to claim 1, wherein:
the heat treatment tool is attached to the workpiece processing unit selectively in combination with at least one of the shaping tool and the finishing tool.

4. The combined processing machine according to claim 1, wherein:
the laser oscillator comprises a semiconductor laser to oscillate a near-infrared laser light at a wavelength of 800 nm to 1000 nm, and
the light guiding portion comprises an optical fiber.

5. The combined processing machine according to claim 1, wherein:
the light focusing head is fixed to the workpiece processing unit through a clamping portion.

6. The combined processing machine according to claim 1, further comprising:
a cooling device that is operable to immediately cool the workpiece heated by a near-infrared laser light emitted from the heat treatment tool to quench the workpiece.

7. The combined processing machine according to claim 6, wherein:
the cooling device comprises a coolant supplying nozzle to supply a coolant to the workpiece during the shaping or the finishing.

8. A processing method by using the combined processing machine according to claim 1, comprising the steps of:
normalizing the workpiece by irradiating the workpiece with a near-infrared laser light by the heat treatment tool and then cooling the workpiece in the air to increase a workability of the workpiece; and
subsequently shaping the workpiece by the shaping tool and/or finishing the workpiece by the finishing tool.
